(19) United States
(12) Patent Application Publication
(10) Pub. No.: US 2026/0222353 A1
(43) Pub. Date: Jul. 30, 2026

(54) Methods and Systems for Virtual Output Queue Assignment

(71) Applicant: Marvell Asia Pte Ltd., Singapore (SG)

(72) Inventors: Moshe Refaeli, Kadima Zoran (IL); Shai Rachmany, Kiryat Ono (IL)

(21) Appl. No.: 19/455,267

(22) Filed: Jan. 21, 2026

Related U.S. Application Data
(60) Provisional application No. 63/749,027, filed on Jan. 24, 2025.

(51) Int. Cl. H04L 47/30; H04L 47/12

(52) U.S. Cl. CPC H04L 47/30; H04L 47/12

(57) ABSTRACT

Embodiments aggregate output content in a multiple queuing system. For example, an embodiment includes a plurality of input queues configured to receive data packets. In the embodiment, each respective data packet received includes a plurality of data chunks, and the plurality of data chunks for a respective data packet, when received in their entirety, define a completed data packet. The embodiment also includes an output buffer configured to maintain a list comprising respective entries of completed data packets received at each of the plurality of input queues, and a control logic configured to read the completed data packets received at at least one of the plurality of input queues based on entries in the output buffer list.

### RELATED APPLICATION

This application claims the benefit of U.S. Provisional Application No. 63/749,027, filed on January 24, 2025. The entire teachings of the above application are incorporated herein by reference.

### BACKGROUND

In computer operating and processing systems, data is often transmitted from one location to another, and a system or process receiving data may be receiving data from multiple sources at a given time. Moreover, the sources transmitting data may be capable of transmitting the data at different data rates. This becomes problematic when trying to aggregate the data received from multiple input queues into a single output queue. Embodiments disclosed herein provide advancements in aggregating output content in multiple queueing systems.

### SUMMARY

An embodiment is directed toward a system for aggregating output content in a multiple queuing system. Such a system may include a plurality of input queues configured to receive data packets, each respective data packet received includes a plurality of data chunks, the plurality of data chunks for a respective data packet when received in their entirety define a completed data packet. Such an embodiment may also include an output buffer configured to maintain a list including respective entries of completed data packets received at each of the plurality of input queues and may also include a control logic configured to read the completed data packets received at at least one of the plurality of input queues based on entries in an output buffer list.

According to an embodiment, each respective entry of completed data packets listed in the output buffer may include at least one of an indication of a position of the respective entry in the output buffer, an indication of a source, and a length of the respective completed data packet. In such an embodiment, the system may be further configured to determine the length of the respective completed data packet by determining a total number of chunks in the respective data packet based on at least one of a first chunk of the plurality of chunks, and a last chunk of the plurality of chunks. Further, in such an embodiment, the indication of the position in the output buffer may be based on a time each input queue of the plurality of input queues received the respective last chunk of the plurality of data chunks for a respective data packet.

According to an embodiment, the output buffer may be further configured to provide information relating to the data packets to the control logic, such as, for example, queue position, packet size, and/or source.

In an embodiment, responsive to the output buffer containing at least one respective entry of a completed data packet, the control logic may be further configured to read the completed data packet corresponding to the respective entry from at least one of the plurality of input queues and transmit the completed data packet read to at least one output queue. In such an embodiment, responsive to the completed data packet read having been transmitted to the at least one output queue in its entirety, the system may delete the respective entry in the output buffer.

In another embodiment, the last chunk of the plurality of chunks of a given data packet received may include an indication that the data packet has been received in its entirety. For example, the last data chunk in the data packet may include an indication that it is the end of packet (EOP).

An embodiment includes a memory configured to hold completed data packets received at the plurality of input queues.

According to an embodiment, the plurality of input queues is a first set of input queues corresponding to a data channel of a first type, the output buffer is a first output buffer corresponding to the channel of a first type, and the control logic is a first control logic corresponding to the channel of a first type. Such an embodiment also includes a second set of a plurality of input queues corresponding to a channel of a second type, a second output buffer corresponding to the channel of a second type, and a second control logic corresponding to the channel of a second type. Such an embodiment may further include an output controller coupled to the first control logic and coupled to the second control logic, the output controller configured to orchestrate transmission of data from the first control logic and the second control logic, respectively, to an output queue.

Another embodiment is directed toward a method for aggregating output content. The method may include receiving respective data packets at a plurality of respective input queues, wherein each respective data packet received includes a plurality of data chunks, the plurality of data chunks for a respective data packet when received in their entirety define a completed data packet. The method further includes maintaining, at an output buffer, a list comprising respective entries of completed data packets received at each of the plurality of input queues, and reading the completed data packets, at a control logic, received at at least one of the plurality of input queues based on entries in the output buffer list.

Yet another embodiment is directed toward means for aggregating output content in a multiple queueing system. The method includes means for receiving respective data packets at a plurality of respective input queues, wherein each respective data packet received includes a plurality of data chunks, the plurality of data chunks for a respective data packet when received in their entirety define a completed data packet. The embodiment further includes means for maintaining, at an output buffer, a list comprising respective entries of completed data packets received at each of the plurality of input queues, and means for reading the completed data packets, at a control logic, received at least one of the plurality of input queues based on entries in the output buffer list.

It is noted that embodiments of the methods, systems, and means may be configured to implement any embodiment, or combination of embodiments, described herein.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a workflow diagram illustrating aggregating output content in a multiple queuing system, according to an embodiment.

FIG. 2 is a flow diagram of a method for aggregating output content in a multiple queuing system, and the method’s associated components, according to an embodiment.

FIG. 3 is a diagram illustrating aggregating output content in multiple queueing systems utilizing an output controller, according to an embodiment.

FIG. 4 is a schematic diagram of an example system for aggregating content from a plurality of multiple input queues, according to an embodiment.

### DETAILED DESCRIPTION

### A description of example embodiments follows.

In multiple queueing systems, there may be a requirement to aggregate the content of multiple input queues located on a single memory into a single output queue, e.g., a carrier output queue. In such a system, a first subset of input queues, of a plurality of input queues, may be configured to receive data packets at a given data rate, and a second subset of input queues may be configured to receive data packets at a given data rate different from the data rate of the first subset. For example, a given channel stored on a memory may be a flexible ethernet (flex-e) channel and a separate channel stored on a separate memory may be a low-bitrate (LB) channel . Embodiments provide for aggregation of the output content received at the multiple input queues into a single output queue at a common data rate. This data rate may be different than the data rate of any of the input queues, if desired.

In a lossless system, i.e., a system that retains all information from input to output, the output channel data rate should be greater than or equal to the sum of the input queue rates. If the output channel data rate is not greater than or equal to the sum of the input queue rates, the data may be waiting and building up at the input queue while the output queue attempts to catch up, which may be a losing battle.

In existing systems, which may be referred to herein as “regular mode,” the content and data structure of the output queue is built up by copying the data in its entirety, or by copying a data pointer, from the input queue to the output queue. In addition, regular mode systems may generate an additional output queue for the aggregated channel and read the data from the additional generated output queue. This legacy approach requires larger power consumption, as the data payload must be copied in its entirety; requires a larger memory footprint, as more memory is needed to store the copied data; and suffers from loss of performance due to the requirement to access the memory to retrieve the data.

Embodiments disclosed herein provide improvements for queuing systems with multiple input queues, i.e., multiple queueing systems, by aggregating channel traffic without copying, moving, or altering the original data received at the multiple input queues. Embodiments enable the aggregation of data packets received at varying data rates from multiple different sources into a single aggregated output queue.

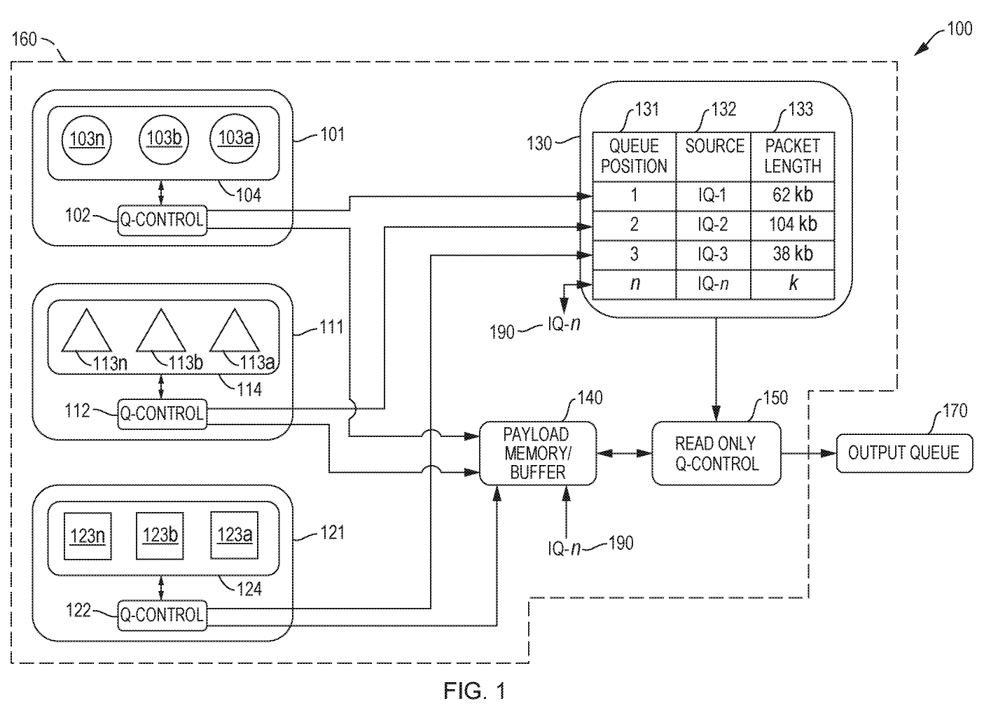

Embodiments add an output buffer (See, 130 of FIG. 1) in parallel with a memory (See, 140 of FIG. 1), where the output buffer contains a transient list of completed data packets received at each of the input queues. For example, the output buffer may be a first-in-first-out (FIFO) buffer, effectively an output-FIFO i.e., OFIFO. In embodiments, the OFIFO buffer may also contain information of the original source queue (i.e., the given input queue), a respective queue position, as well as the length of the data packet. Embodiments may also provide a dedicated read-only queue control logic (RO Q-Control) (See, 150 of FIG. 1) that transmits the completed data packets stored in the memory at the rate of the output queue (See, 170 of FIG. 1), based on an indication received by the OFIFO.

In embodiments, for each input queue, an input queue control logic (Q-Control) may transmit the data packet to a common payload memory associated with the given channel (i.e., there may be a first payload memory associated with, for example flex-e, and a second payload memory associated with, for example, LB). Moreover, once the Q-Control has identified that a data packet has been received in its entirety, the Q-Control may transmit information related to the completed data packet to the output buffer (See, 130 of FIG. 1). Such information may include the packet length and respective position in the output buffer queue.

According to an embodiment, when the OFIFO buffer is not empty, and there is an active slot available in the output queue, the RO Q-Control may begin reading the data packet received in the payload memory from the original input queue and transmitting the data packet to the output queue. This may create a situation where the input queue has two identifiers (IDs), one for writing (i.e., the original) and one for reading (i.e., the virtual). This configuration may allow for the reading and writing of data without moving the data. For example, each input queue may include two IDs. The first ID may be for the input queue, i.e., the write operation, and the first ID is unique for the input queue. The second ID may be a virtual ID used for the read operation and the virtual ID may be shared among the input queues. Therefore, the same data structure (e.g., input queue) may include two different IDs assigned during system configuration.

To continue, the data packet may continue to be read by the output queue (See, 170 of FIG. 1) until the entire data packet has been read. Once the entire packet has been read, the output buffer is “popped” (i.e., the top level entry is deleted from the buffer and the next level entry is then promoted to the top level entry, wherein the top level entry is the next candidate for transmission to the output queue) and the data packet associated with the next queue position may be transmitted to the output queue. Effectively, the Q control operates in a store and forward mode of operation.

Therefore, embodiments effectively re-map the channels without changing the original packet structure. Data packets may be received by the input queues at different data rates but are output by the system at a common data rate.

Further, by not having to duplicate data by copying or moving the data from the input queue to a memory, embodiments save storage space by not requiring an additional memory, and save time by not requiring the data to be copied. Therefore, embodiments provide for time savings and memory savings and as such increase performance.

FIG. 1 is a workflow diagram of a system 100 for aggregating output content in a multiple queuing system, according to an embodiment. Such an embodiment may include multiple input queues. For example, an embodiment may include input queue one (IQ-1) 101, input queue two (IQ-2) 111, and input queue three (IQ-3) 121. It should be understood that while only three input queues 101, 111, and 121 are illustrated in method 100, method 100 may utilize any number of input queues as illustrated in input queue “n” (IQ-n) 190.

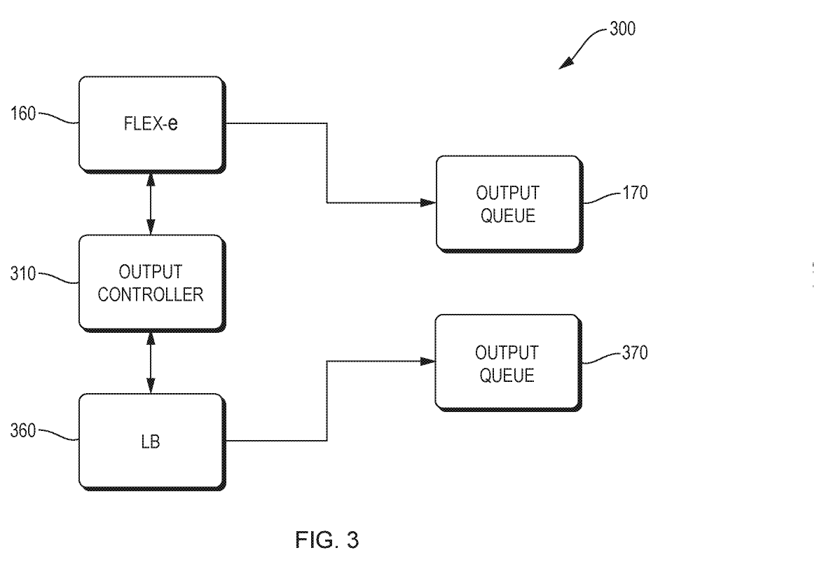

Grouping 160 of components of FIG. 1 to be further referenced herein below in relation to FIG. 3.

A given input queue, for example IQ-1101, may receive a plurality of data chunks 103a-n at a given data rate. The data chunks 103a-n, when received by IQ-1101 in their entirety, define a completed data packet 104. A given input queue control (Q-Control), e.g., Q-Control 102 for IQ-1101, may store the data packet 104 payload received in a payload memory, e.g., payload memory / buffer 140. Once the Q-Control 102 has received the data packet 104 in its entirety, for example chunk 103n has indicated that chunk 103n is the end of packet (EOP), the Q-Control 102 may write to the output buffer 130 (i.e., the OFIFO) an entry of the completed data packet 104 received at IQ-1 101. Each of the input queues IQ-1 101, IQ-2 111, IQ-3 21, through IQ-n 191 operate similarly. For example, IQ-2 111 may receive a plurality of data chunks 113a-n at a given data rate. The data chunks 113a-n, when received by IQ-2111 in their entirety, define a completed data packet 114. Q-Control 112 may store the data packet 114 payload in payload memory / buffer 140. Once the Q-Control 112 has received the data packet 114 in its entirety, Q-Control 12 may write to the output buffer 130 an entry of the completed data packet 114 received at IQ-2 111. To continue, IQ-3 121 may receive a plurality of data chunks 123a-n at a given data rate. The data chunks 123a-n, when received by IQ-3121 in their entirety, define a completed data packet 124. Q-Control 122 may store the data packet 124 payload in payload memory / buffer 140. Once the Q-Control 122 has received the data packet 124 in its entirety, Q-Control 122 may write to the output buffer 130 an entry of the completed data packet 124 received at IQ-3121.

According to an embodiment, the output buffer 130 maintains a list of respective entries of completed data packets (104, 114, 124) received at each of the plurality of input queues (101, 111, 121). The output buffer 130 includes information relating to a queue position 131, a source 132 (e.g., from which input queue is the indication from), and a packet length 133. When a respective input queue (101, 111, 121) receives a respective complete data packet (104, 114, 124), the respective control logic (102, 112, 122) communicates that it has received a completed packet to the output buffer 130, and also provides the output buffer 130 with an indication of the data packet length (e.g., size) 133. These entries are put into the output buffer 130 in a first in first out basis. For example, if IQ-1 101 has received its completed data packet 104 at t = 1, where t is an arbitrary time unit, and IQ-2 111 has received its completed data packet 114 at t > 1, the indication of the data packet 104 will be placed in a higher queue position 131 in the output buffer 130 regardless of its respective packet length 133. It should be understood that values provided for packet length 133 are arbitrary placeholders.

According to an embodiment, a read only queue control (RO Q-Control) 150 may receive a command (e.g., an indication that the output buffer is not empty) from the output buffer 130 that it is a given packet’s turn (i.e., the packet with the next queue position) to be sent to the output queue 170. The RO Q-Control 150 may then identify the given packet in the payload memory 140 and transmit the packet from the payload memory 140 to the output queue 170.

In a lossless system, the depth of the output buffer 130 may have an associated depth equal to the maximum number of data packets that could be stored in the data buffer (e.g., 104). Such a configuration may be advantageous where each data packet is a shared data bus (SDB) packet.

According to an embodiment, the RO Q-Control (e.g., 150) may contain a prefetch buffer. The prefetch buffer may be utilized to minimize or eliminate latency of the payload memory 140 by preparing the next available data packet to be sent out prior to it being requested. For example, when the prefetch buffer has available space, it may be re-filled with information relating to the completed data packets.

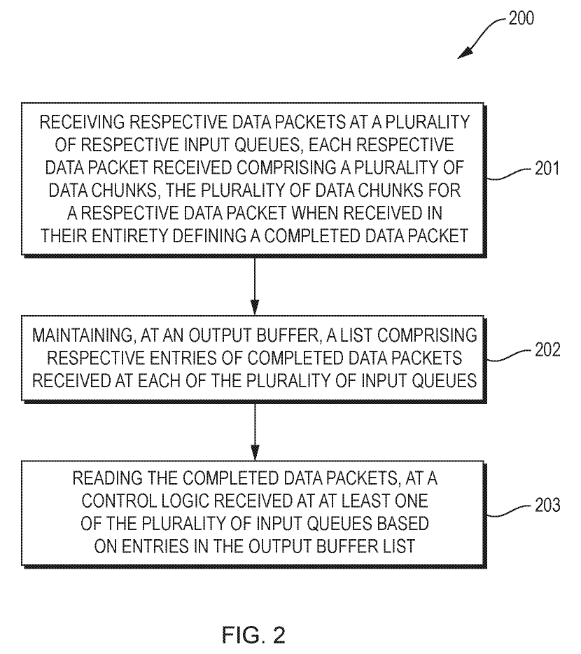

FIG. 2 is a flow diagram of a method 200 for aggregating output content in a multiple queuing system. The method 200 begins at step 201 by receiving respective data packets (See, 102, 112, 122 of FIG. 1) at a plurality of respective input queues (See, 101, 111, 121 of FIG. 1); each respective data packet received includes a plurality of data chunks (See, e.g., 103a-n of FIG. 1), and the plurality of data chunks for a respective data packet, when received in their entirety, define a completed data packet (See, e.g., 104 of FIG. 1). Thereafter, at step 201, method 200 continues by maintaining, at the output buffer, (e.g., the OFIFO buffer) (See, 130 of FIG. 1) a list including respective entries of completed data packets received at each of the plurality of input queues. Next, at step 201, the method 200 reads the completed data packets, at a control logic (See, e.g., 150 of FIG. 1), received at least one of the plurality of input queues based on entries in the output buffer list.

In some embodiments of the method 200, each respective entry of completed data packets listed in the output buffer may include at least one of an indication of a position (See, 131 of FIG. 1) of the respective entry in the output buffer, and a length (See, 133 of FIG. 1) of the respective completed data packet. Such an embodiment of method 200 may further include determining a length of the respective completed data packet by determining a total number of chunks (e.g., see 105a-n of FIG. 1) in the respective data packet based on at least one of the first chunk, of the plurality of chunks, and the last chunk, of the plurality of chunks. For example, the first chunk may include an indication of the size of the data packet, and embodiments may count the number of chunks received until that indication has been reached. In some embodiments, the last data chunk of the plurality of chunks of a given data packet received may include an indication that the data packet is the last data chunk in the packet, thereby indicating that the data packet has now been received in its entirety.

In the method 120, the indication of the position of a respective entry of completed data packets listed in the output buffer may be based on a time each input queue of the plurality of input queues received the respective last chunk of the plurality of data chunks for a respective data packet. For example, the entries are listed in the output buffer on a first in, first out basis. Once an input queue has received an indication that the last data chunk has been received for a given data packet, i.e., that the data packet has been received in its entirety, the respective entry of the respective data packet may be written to the output buffer. The entries in the output buffer are queued relative to when the respective input queue received the data packet in its entirety, e.g., the entries are listed in a first-in-first-out basis. In some embodiments, information from the output buffer may be provided to the RO Q-Control, such as the entries’ position in the queue as well as their packet length and input queue number.

In some embodiments, responsive to the output buffer containing at least one respective entry of a completed data packet, the method 200 may also include, by the control logic (i.e., RO Q-Control), reading the completed data packet corresponding to the respective entry from at least one of the plurality of input queues and transmitting the completed data packet to at least one output queue. In such an embodiment, responsive to the completed data packet being transmitted to the at least one output queue in its entirety, the method 200 may then delete the respective entry in the output buffer.

Some embodiments of the method 200 may further include a memory (See, 140 of FIG. 1) configured to hold completed data packets received at the plurality of input queues. According to an embodiment, the memory may be any method of data storage.

According to an embodiment of the method 200, the plurality of input queues may be a first set of input queues corresponding to a data channel of a first type (e.g., flex-e), the output buffer may be a first output buffer corresponding to the channel of a first type, and the control logic may be a first control logic corresponding to the channel of a first type, In such an embodiment, the method 200 may further include a second set of a plurality of input queues corresponding to a channel of a second type (e.g., LB), a second output buffer corresponding to the channel of a second type, and a second control logic corresponding to the channel of a second type. In such an embodiment, an output controller may be coupled to both the first control logic and to the second control logic, the output controller configured to orchestrate transmission of data from the first control logic and the second control logic, respectively, to an output queue. For example, the output controller may provide an indication to each respective control logic that it is their turn to transmit data to the output queue. In this way, the output controller orchestrates the data being transmitted to the output queue.

As disclosed hereinbelow in relation to diagram 300 of FIG. 3, according to an embodiment, one or more input queues of the plurality of input queues may be associated with a first type of channel, for example a flexible ethernet (flex-e) channel (See, 160 of FIG. 3), and one or more input queues of the plurality of input queues may be associated with a second type of channel (See, 160 of FIG. 3), for example a low-bitrate (LB) channel. The first type of channel and the second type of channel may receive and transmit data at different rates. In such an embodiment, there may be a respective payload memory / buffer (e.g., 140) for the first type of channel, and a respective payload memory / buffer for the second type of channel. There may also be a respective output buffer (i.e., the OFIFO) for the first type of channel and a respective output buffer for the second type of channel. In addition, there may be a respective RO Q-Control (e.g., 150) for the first type of channel, and a respective RO Q-Control for the second type of channel. In such an embodiment there may be an output queue 170 for the data from the channels of a first type, and an output queue 370 for the data from the channels of a second type.

Such an embodiment may further include an output controller (See, 310 of FIG. 3) in communication with the respective RO Q-Controls for the channels of the first type and the channels of the second type. The output controller 310 may be configured to provide an indication to a given RO Q-Control (i.e., either the RO Q-Control associated with the first channel type, or the RO A-Control associated with the second channel type) that it is that given RO Q-Control’s turn to send a data packet to the output queue 170. Such an indication may be based on a calendar ID associated with the completed data packet received by a given Q-Control (e.g., a first ID) and a calendar ID associated with the output controller (e.g., a second ID). For example, when there is a match between the calendar ID associated with the Q-Control and the calendar ID associated with the output controller, data is sent to the respective output queue. The output controller may be configured to provide the indication at every clock cycle, effectively alternating between outputting from the first channel and outputting from the second channel.

FIG. 3 is a diagram 300 illustrating aggregating output content in multiple queueing systems, according to an embodiment. In FIG. 3, the grouping of components 160 of FIG. 1 may be associated with a plurality of input channels (e.g., 101, 111, 121 of FIG. 1) associated with a first channel type, for example, flex-e. Grouping of components 360 may be analogous to grouping of components 160 in nearly all aspects, except the plurality of input channels associated grouping of components 360 may be associated with a second channel type, for example LB. The output controller 310 may be configured to communicate with the respective RO Q-Controls associated with 160 and 360. At each clock cycle, the output controller 310 may send an indication to the RO Q-Control associated with either 160 or 360 to transmit a given data packet to a respective output queue 170 associated with the first channel type 160, or a respective output queue 370 associated with the second channel type 360. It should be understood that while the output buffer associated with the first channel type may be written to at the same time the output buffer associated with the second channel type is written to, but only one may drive data at a time. In this way, embodiments aggregate content from multiple input queues at a plurality of data rates into a single output queue.

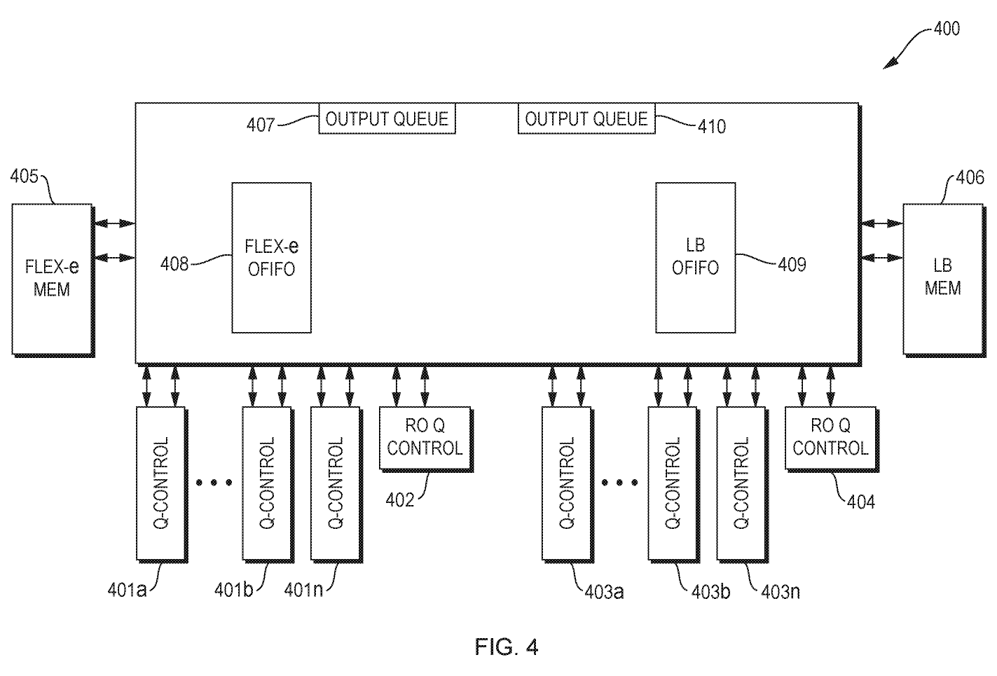

FIG. 4 is a schematic diagram of an example system 400 for aggregating content from a plurality of multiple input queues, according to an embodiment. System 400 includes a plurality of input queues 401a-n associated with a first channel type, for example, flex-e, and a plurality of channels 403a-n associated with a second channel type, for example, LB. It should be understood that while only two channel types are shown and described, embodiments are sufficient to be implemented with any number of input channels and any number of channel types. Each plurality of input queues 401a-n, and 403a-n also has an associated RO Q-Control, 402 and 404, respectively. System 400 also includes a data buffer associated with the memory of the first type 405, and a data buffer associated with memory of the second type 406. Both data buffers 405 and 406 may include respective memories and respective memory control logics. Further, system 400 may include an output buffer 408, i.e., OFIFO, associated with data of the first type, and an output buffer 409 associated with data of the second type. System 400 also includes an output queue 407 for data of the first type (e.g., flex-e) and an output queue 410 for data of the second type (e.g., LB) to transmit data off system 400.

Embodiments support both “regular mode” as well as store and forward mode, and may be configured to implement one, the other, or both at the same time. However, during store and forward mode, the control logic operation may differ from “regular mode” (legacy methods and systems). In store and forward mode, a given data packet must be received in its entirety and fully stored in the buffer (See, 140 of FIG. 1) before information about the data packet can be written to the output buffer, and the payload transmitted to the output queue. In such an embodiment, each respective input Q-Control logic may count the number of completed data packets in its queue buffer and increase a counter with each completed data packet counted. According to an embodiment there may be a first counter for queue size in packets, and a second counter for queue size in chunks. In store and forward mode, the counter associated with packets must be greater than “0” in order to begin reading from the queue, whereas during “regular mode” it may be sufficient that the counter associated with chunks is not empty in order to start transmitting a data packet.

An additional difference between embodiments and legacy systems is that, in embodiments, several Q-Control units may share the same carrier channel (e.g., flex-e or LB), but only one carrier channel at a time can drive data. Therefore, in order to reduce the number of channel buffers required, embodiments use a dedicated RO Q-Control to perform reading operation and data prefetch. To continue, when the output buffer is not empty, the RO Q-Control begins reading data from a prefetch buffer every time there is a calendar ID match between the data and the output controller and then transmits the data to the output queue. The RO Q-Control reads and transmits data to the output queue until the data packet is read in its entirety. After the data packet is read in its entirety, the respective entry in the output buffer is “popped,” and the next data packet may be a candidate for transmission to the output queue.

An embodiment may include a loopback operation. The loopback operation also works in a store and forward configuration and also utilizes a dedicated carrier channel (e.g., flex-e or LB) to send the traffic out from the shared memory. However, in the loopback embodiment, the out-going loopback traffic carrier channel may be different than the incoming loopback traffic channel, i.e., there may be a channel re-mapping. Channel re-mapping may be performed in, for example, flex-e channels as well. Channel re-mapping may be performed when the output selection RO Q-Control is read. The RO Q-Control is read if the calendar channel ID is equal to the configured loopback carrier channel ID. Moreover, the loopback carrier channel bit rate is predefined, whereas the incoming loopback traffic bit rate is not predefined, and could go up to the maximum hardware allowable bit rate, which may lead to memory overflow. In the case of memory overflow, the loopback packets may be discarded.

While example embodiments have been particularly shown and described, it will be understood by those skilled in the art that various changes in form and details may be made therein without departing from the scope of the embodiments encompassed by the appended claims.

What is claimed is:

1. A system for aggregating output content in a multiple queuing system, the system comprising:
a plurality of input queues configured to receive data packets, each respective data packet received comprising a plurality of data chunks, the plurality of data chunks for a respective data packet when received in their entirety defining a completed data packet;
an output buffer configured to maintain a list comprising respective entries of completed data packets received at each of the plurality of input queues; and
a control logic configured to read the completed data packets received at at least one of the plurality of input queues based on entries in the output buffer list.

2. The system of claim 1, wherein each respective entry of completed data packets listed in the output buffer comprises at least one of an indication of a position of the respective entry in the output buffer, an indication of a source, and a length of the respective completed data packet.

3. The system of claim 2, wherein the system is further configured to determine the length of the respective completed data packet by the system being further configured to determine a total number of chunks in the respective data packet based on at least one of a first chunk of the plurality of chunks, and a last chunk of the plurality of chunks.

4. The system of claim 2, wherein the indication of the position in the output buffer is based on a time each input queue of the plurality of input queues received the respective last chunk of the plurality of data chunks for a respective data packet.

5. The system of claim 1, wherein the output buffer is further configured to provide information relating to the data packets to the control logic.

6. The system of claim 1, further comprising, responsive to the output buffer containing at least one respective entry of a completed data packet, the control logic being configured to read the completed data packet corresponding to the respective entry from at least one of the plurality of input queues and transmit the completed data packet read to at least one output queue.

7. The system of claim 6, wherein, responsive to the completed data packet read being transmitted to the at least one output queue in its entirety, the system is further configured to delete the respective entry in the output buffer.

8. The system of claim 1, wherein the last chunk of the plurality of chunks of a given data packet received comprises an indication that the data packet has been received in its entirety.

9. The system of claim 1, further comprising a memory configured to hold completed data packets received at the plurality of input queues.

10. The system of claim 1, wherein the plurality of input queues are a first set of input queues corresponding to a data channel of a first type, the output buffer is a first output buffer corresponding to the channel of a first type, and the control logic is a first control logic corresponding to the channel of a first type, the system further comprising:
a second set of a plurality of input queues corresponding to a channel of a second type, a second output buffer corresponding to the channel of a second type, and a second control logic corresponding to the channel of a second type.

11. The system of claim 10, further comprising an output controller coupled to the first control logic and coupled to the second control logic, the output controller configured to orchestrate transmission of data from the first control logic and the second control logic, respectively, to an output queue.

12. A method for aggregating output content, the method comprising:
receiving respective data packets at a plurality of respective input queues, each respective data packet received comprising a plurality of data chunks, the plurality of data chunks for a respective data packet when received in their entirety defining a completed data packet;
maintaining, at an output buffer, a list comprising respective entries of completed data packets received at each of the plurality of input queues; and
reading the completed data packets, at a control logic, received at least one of the plurality of input queues based on entries in the output buffer list.

13. The method of claim 12, wherein each respective entry of completed data packets listed in the output buffer comprises at least one of an indication of a position of the respective entry in the output buffer, an indication of a source, and a length of the respective completed data packet.

14. The method of claim 13, further comprising, determining the length of the respective completed data packet by, determining a total number of chunks in the respective data packet based on a first chunk of the plurality of chunks and a last chunk in the plurality of chunks.

15. The method of claim 13, wherein the indication of the position in the output buffer is based on a time each input queue of the plurality of input queues received the respective last chunk of the plurality of data chunks for a respective data packet.

16. The method of claim 12, further comprising providing information relating to the data packets, via the output buffer, to the control logic.

17. The method of claim 12, responsive to the output buffer containing at least one respective entry of a completed data packet, the method further comprises, by the control logic, reading the completed data packet corresponding to the respective entry from at least one of the plurality of input queues and transmitting the completed data packet to at least one output queue.

18. The method of claim 17, further comprising, responsive to the completed data packet being transmitted to the at least one output queue in its entirety, deleting the respective entry in the output buffer.

19. The method of claim 12, wherein the last chunk of the plurality of chunks of a given data packet received comprises an indication that the data packet has been received in its entirety.

20. The method of claim 12, further comprising a memory configured to hold completed data packets received at the plurality of input queues.

21. The method of claim 12, wherein the plurality of input queues are a first set of input queues corresponding to a data channel of a first type, the output buffer is a first output buffer corresponding to the channel of a first type, and the control logic is a first control logic corresponding to the channel of a first type, the method further comprising:
configuring a second set of a plurality of input queues corresponding to a channel of a second type, configuring a second output buffer corresponding to the channel of a second type, and configuring a second control logic corresponding to the channel of a second type.

22. The method of claim 21, further comprising methodizing, by an output controller coupled to the first control logic and coupled to the second control logic, transmission of data from the first control logic and the second control logic, respectively, to an output queue.

23. Means for aggregating output content in a multiple queueing system, comprising:
means for receiving respective data packets at a plurality of respective input queues, each respective data packet received comprising a plurality of data chunks, the plurality of data chunks for a respective data packet when received in their entirety defining a completed data packet;
means for maintaining, at an output buffer, a list comprising respective entries of completed data packets received at each of the plurality of input queues; and
means for reading the completed data packets, at a control logic, from received at least one of the plurality of input queues based on entries in the output buffer list.
